(19) United States
(12) Patent Application Publication
(10) Pub. No.: US 2010/0240348 A1
(43) Pub. Date: Sep. 23, 2010

(54) METHOD TO CONTROL VIDEO TRANSMISSION OF MOBILE CAMERAS THAT ARE IN PROXIMITY

(76) Inventors: Ran Lotenberg, Raanana (IL); Bahram Nour-Omid, Los Angeles, CA (US)

Correspondence Address: SMITH FROHWEIN TEMPEL GREENLEE BLAHA, LLC, Two Ravinia Drive, Suite 700, ATLANTA, GA, 30346, US

(21) Appl. No.: 12/725,990

(22) Filed: Mar. 17, 2010

Related U.S. Application Data
(60) Provisional application No. 61/161,002, filed on Mar. 17, 2009.

(51) Int. Cl. H04M 3/42

(52) U.S. Cl. 455/414.1

(57) ABSTRACT

A method to manage the transmission of multiple mobile cameras that are in close proximity to each other or at least one other in the group of multiple mobile cameras. The cameras detect that the are proximate to one or more other cameras either autonomously or with the aid of other systems such as GPS, cellular or server systems. The quality level of the transmissions of the mobile video cameras is controlled, and/or the resources dedicated to the mobile units are augmented to coordinate the transmissions.

### CROSS-REFERENCE TO RELATED APPLICATIONS

This is a non-provisional application for a U.S. Patent being filed under 35 C.F.R. 1.53 (b) and 35 U.S.C. 111 and claiming the benefit of priority to U.S. Provisional Application for Patent filed on Mar. 17, 2009 and assigned Ser. No. 61/161,002, which application is incorporated herein by reference in its entirety.

### BACKGROUND

1. Field of Invention

The present invention relates to the control of mobile cameras and, more specifically to a method and apparatus for controlling several transmitting proximate mobile cameras.

2. Description of Background Art:

There are many methods to control video streaming of (mobile) cameras. These include manually configuring the bit rate by a user, automatically upon image processing event, or by the available network resources.

Cellular networks distribute available network resources among users. The common way is to try and distribute the resources evenly.

### SUMMARY

The disclosed embodiments provide a novel and new method to manage several transmitting proximate mobile cameras. Our innovation offers a set of procedures for several mobile transmitting camera units to coordinate transmission when they are in close proximity to each other. The output of the coordination is a quality level, ie, bit rate transmission level, for each unit.

The motivation to coordinate the transmitting units elevates from the fact that once in proximity, the units can saturate the local network with video data. For example, if all units operate within one cellular cell, their data upload requirements can be higher than the cellular systems resources for radio transmission. In this case, the radio resources allocated to each unit may be so low as to make the video quality unusable.

The first issue is to determine that units are in close proximity to each other and that this causes them to share common network resources. In some embodiments, it is assumed that physical proximity implies sharing of common network resources. In other embodiments, this assumption is relaxed and as is shown, a method to infer logical proximity for cellular networks is employed.

### DETAILED DESCRIPTION

In the present disclosure, the first method to learn about proximity is sensing. Units can sense each other by means of wireless networks. A unit can send a beacon with a unique ID. Other units can listen to this beacon and once received infer that they are in proximity to other units.

In the present disclosure, the second method to learn about proximity is GPS information. It is assumed that units send video to a central server. In this case units can learn about their proximity from this a central server after sending it their GPS location. This information is maintained and updated in real-time to reflect the real word situation.

In the present disclosure, the third method to learn about proximity is from a cellular network. A key point to notice is that proximity is not necessary physical proximity, sometimes there is logical proximity where units share common network resources, although they are not necessarily physically close to each other. This may be the case when units use cellular network to communicate. Units can learn about proximity by looking at the sector identifier or cell identifier. As with the GPS information, the sector or cell identifier is sent to a central server which gathers all the location information, the server can conclude proximity and send this information back to the units.

In the present disclosure, the forth method is to learn about logical proximity from inspection of the correlation of available bandwidth. For example, the system can “see” that when one unit uses higher a bit rate, a second unit has less available bandwidth to the server. In this case, the system can use heuristics to infer logical proximity.

In addition the new method can combine the above mentioned proximity mechanisms to infer proximity.

Once proximity is set, and it is assumed that proximity implies sharing of network resources, there may be a need to coordinate the usage of the (shared) network resources among the different units. If there are network resources sufficient enough to stream all units at highest quality than there is no need for coordination. However, it is anticipated that practical scenarios would saturate local networks; hence there is a strong need for coordination to allow the required video quality from a remote location, where the units are located.

The new method offers these coordination configurations: automatic, semi-automatic, and manual configurations.

In automatic coordination configuration, a central server, receiving the video inputs decides and instructs each camera in which quality to send video. The decision is based on overall video quality from all cameras or based on needed visual information to achieve full information (eg., to cover a 360 degrees of a room.). Thus, the automatic coordination configuration provides great flexibility in serving the various video transmitters. For instance, one video transmitter may be assigned a higher priority for a period of time and then, a different video transmitter may be assigned that priority at a later time, after the first video transmitter is completed or after a given period of time. Thus, a time division sharing of the resources can be effectuated. Similarly, the type of video content can be analyzed in real time and priorities can be assigned accordingly. In other embodiments, the error rate of a video stream can be monitored and then additional bandwidth or priority assigned to the video transmitter experiencing the most errors.

In semi-automatic coordination configuration, each camera gets a priority level and when in proximity, each camera unit transmits according to predefined quality levels. An alternate coordination is to distribute the available bandwidth, from the location to the central server, according to the priory levels. The formula for this is:

bit rate=priority-level*aggregated-bandwidth/total-sum-of-priority-levels.

In manual coordination configuration, a human operator instructs the quality level for each camera.

In addition in the new method, a human operator can decide when to have manual coordination and when to let the system decide on the appropriate coordination (i.e., “auto pilot”). In manual mode, the operator specifically chooses which camera(s) she wants to see in high quality and which in low quality. In auto pilot, the system decides the appropriate quality level for each camera.

Yet another innovation in the new method is for the proximate devices to form a mesh networks and stream collectively to the server. This scenario is valid only when units have a local network over which they form a local mesh network and use their remote communication facilities, like cellular modems, to connect to the server. Or when they form a mesh network up to the server.

Other objectives, features, and advantages of the present invention will become apparent upon reading the following detailed description of the embodiments with the accompanying drawings and appended claims.

What is claimed is:

1. A method for managing the transmission of a plurality of mobile cameras that are proximate to each other, the method comprising the steps of:
determining when two or more mobile cameras are proximate to each other;
employ a set of procedures to coordinate the transmissions of the two or more mobile cameras that are proximate to each other wherein the coordination results in establishing a quality level for the transmissions of each of the two or more mobile cameras.

2. The method of claim 1, wherein the two or more mobile cameras includes sensors and, the step of determining when two or more mobile cameras are proximate to each other further comprises one or more mobile cameras detecting another mobile camera in proximity through the use of the sensors.

3. The method of claim 1, wherein the two or more mobile cameras include GPS technology and, the step of determining when two or more mobile cameras are proximate to each other further comprises one or more mobile cameras receiving information regarding the GPS coordinates of another mobile camera and comparing the received GPS coordinates to its own GPS coordinates to determine that the mobile cameras are proximate to each other.

4. The method of claim 1, wherein two or more mobile cameras include cellular technology and, the step of determining when two or more mobile cameras are proximate to each other further comprises examining cellular location based information.

5. The method of claim 4, wherein the step of examining cellular location based information includes identifying the current cell sites for two or more mobile cameras.

6. The method of claim 5, wherein one mobile camera determining that another mobile camera is proximate based on the current cell sites of the two mobile units is logical proximity, and further comprising the step of sharing common network resources by examining the correlation between bandwidth usage.

7. The method of claim 1, wherein the step of coordinating the transmission of the two or more mobile cameras is based on automatic, semi-automatic, and manual configurations.

8. The method of claim 7, wherein the step of coordinating based on an automatic coordination configuration further comprises a central server configured to receive the video signals from the two or more mobile cameras, the central server being further configured to:
examine the overall video quality from at least a subset of the two or more mobile cameras;
send control signals to each mobile camera in the subset to identify the quality level for each particular mobile camera to transmit video.

9. The method of claim 7, wherein the step of coordinating based on a semi-automatic coordination configuration further comprises the steps of:
assigning a priority level to each of the two or more mobile cameras;
each mobile camera transmitting in accordance with the assigned quality levels.

10. The method of claim 7, wherein the step of coordinating based on a semi-automatic coordination configuration further comprises the steps of:
assigning a priority level to each of the two or more mobile cameras;
each mobile camera having access to a portion of the available bandwidth based upon its assigned quality level.

11. The method of claim 7, wherein the step of coordinating based on a manual coordination configuration further comprises the steps of:
a human operator causing signals to be sent to each of the two or more mobile cameras thereby setting the quality level for the transmissions of each mobile camera to either increase, decrease or cease.

12. The method of claim 11, wherein rules are applied to determine when to manual coordination and automatic coordination should be used.

13. The method of claim 12, further comprising the step of two or more of the mobile cameras collectively coordinating their video quality level.

14. The method of claim 13, wherein each of the two or more mobile camera are communicatively coupled to a server, the server being configured to perform the steps of coordinating the transmissions of the mobile cameras and instructing the mobile cameras to transmit at particular quality levels.
